(19) United States
(12) Patent Application Publication
(10) Pub. No.: US 2017/0185746 A1
(43) Pub. Date: Jun. 29, 2017

(54) ELECTRONIC MEDICATION DISPENSER

(71) Applicant: LUNATECH, LLC, Studio City, CA (US)

(72) Inventor: John D. Cameron, Studio City, CA (US)

(21) Appl. No.: 15/388,868

(22) Filed: Dec. 22, 2016

Related U.S. Application Data
(60) Provisional application No. 62/271,859, filed on Dec. 28, 2015.

(51) Int. Cl. G06F 19/00

(52) U.S. Cl. CPC G06F 19/3462

(57) ABSTRACT

Provided are systems, methods, and electronic medication dispensers that utilize a secure electronic tracking, communication and dispensing method for the accurate disbursement of medication.

### CLAIM OF PRIORITY

This application claims priority to provisional patent application Ser. No. 62/271,859 filed Dec. 28, 2015, the contents of which are hereby incorporated by reference.

### BACKGROUND

Medications in pill form are normally provided in a disposable plastic container with a childproof cap. When the medication is prescribed, a doctor and/or pharmacist provide patients of proper precautions and usage of the medication such as appropriate storage, dosage of the medication to take, time to take the medication, and duration of use of the medication. However, patients do not always follow instructions provided by the doctor and/or pharmacist and may forget to take the medication, take too much medication, or not take the medication for an entire regiment. Also, a childproof cap can easily be opened by those not authorized to take the medication. It would be desirable, therefore, to have a medication dispenser that is secure, dispenses the medication when the medication is to be taken, and provides alerts to users of the medication dispenser when to take and refill the medication.

### SUMMARY

It is to be understood that both the following general description and the following detailed description are exemplary and explanatory only and are not restrictive. In an aspect, disclosed herein is a system, method and device deployment of an electronic smart pill dispensing device which dispenses pills as directed by system controllers to securely and precisely provide users with the proper medication dosage in pill form.

In another aspect, provided is an apparatus comprising a memory storing control instructions for dispensing a medication. The apparatus can comprise a controller, configured to determine a dose of a medication to dispense based on the control instructions. The apparatus can comprise a dispensing component. The dispensing component can comprise one or more containers for storing the medication, and a dispensing channel, coupled to the processor, configured for dispensing a selectable amount of medication from each of the one or more containers based control instruction. The apparatus can comprise a receiving entity coupled to the dispensing channel and configured to receive the selectable amount of medication from the dispensing channel and provide the selectable amount of medication to a user.

In a further aspect, provided is a method comprising receiving at an electronic medication dispenser a control instruction for dispensing a medication from the electronic medication dispenser, storing the control instruction in a memory device, processing the control instruction with a controller, monitoring for one or more conditions based on the control instruction, determining the one or more conditions have been satisfied, and dispensing the medication based on the control instruction when the one or more conditions have been satisfied.

In another aspect, provided is a method comprising generating first data related to a first electronic medication dispenser, transmitting the first data to a central server, receiving second data from the central server, determining which of the first data or the second data is current storing either the first data the second data based on which is current, and providing the stored data to a user of the first electronic medication dispenser.

In a further aspect, provided is a method comprising generating, by an electronic medication dispenser, first data related to the electronic medication dispenser, transmitting the first data to a central server, receiving, by an electronic device, second data from the central server, wherein the second data comprises the first data, and providing the second data to a user of the electronic device.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive.

### BRIEF DESCRIPTION OF THE DRAWINGS

The features, nature, and advantages of the present disclosure will become more apparent from the detailed description set forth below when taken in conjunction with the drawings, in which like reference characters are used to identify like elements correspondingly throughout the specification and drawings.

FIG. 1 illustrates a block diagram of an exemplary electronic medication dispenser;

FIG. 2 illustrates an example operating environment:

FIG. 3 illustrates an example method;

FIG. 4 illustrates an example method;

FIG. 5 illustrates an example method; and

FIG. 6 illustrates an example computer system.

### DETAILED DESCRIPTION

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes [symbol] from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Various aspects are now described with reference to the drawings. In the following description, for purposes of explanation, numerous specific details are set forth in order to provide a thorough understanding of one or more aspects. It may be evident, however, that the various aspects may be practiced without these specific details. In other instances, well-known structures and devices are shown in block diagram form in order to facilitate describing these aspects.

In an aspect, disclosed is an electronic medication dispenser (ePill bottle) enabled with a broad range of functionality options. These functionalities are enabled by a microprocessor controller utilized to execute commands for system functionality, along with a memory, transmitter, software, storage and a power system. The electronic medication dispenser has an electronics package under for lighting effects, and a separate control feature for a “human proof” cap.

An electronically tamper proof seal is accomplished by a locking mechanism unlocked only once the electronic medication dispenser has been positioned and verified via a verification mechanism such as matching frequency (e.g., 107.8 kHz), creating an electronic data ‘handshake’, software verification, physical hardware lock-and-key matching, combinations thereof, and the like. The verification mechanism of the locking mechanism may be reset between the devices via password or routine/default security control settings where the exact verification mechanism may be reset as a physical encryption between the electronic medication dispenser and a user device.

Once unlocked, a dispensing system of the electronic medication dispenser and a receiving entity of the electronic medication dispenser is set to transfer a calibrated and verified dosage of medication (e.g., pill, powder, liquid, gas, and the like) based upon the information transferred and verified between the dispensing system and receiving entity, as well as data which may be input via an authorized third party device, such as a physician, or other caregiver, and the like. The dispensing system and receiving entity may be used to hold and deliver medications, wellness ingredients and any material in solid form, capable of being calibrated.

The calibration takes place as sensors in each of the dispensing system and the receiving entity of the electronic medication dispenser calibrate the amount of medication, which is passed from the dispensing system to the receiving entity. The medication is identified, transferred and verified via one or more sensors, which are verified by multi-point sensing within each device. An interlocking interior mechanism can isolate individual medication dosages (e.g., a pill) to control the movement of each medication dosage within the dispensing system, further, the interior walls of the electronic medication dispenser may contract or expand to maintain control and configure each medication dosage within the electronic medication dispenser.

Once filled with the calibrated amount of medication, the electronic medication dispenser via the dispensing system may then dispense directly into the receiving entity where the user or authorized party can access the medication and/or be ingested directly by the user or authorized party or be transferred to a third party receptacle or device for use. The user may be authorized by fingerprint, ‘voiceprint, password input, retinal scan, microbial ‘fingerprint’ and the like.

A record of usage of the electronic medication dispenser is chronicled and archived via transmission to authorized user accounts and may be accessed by the user and authorized third parties. Users can then verify times and dosages received, if they have forgotten or simply would like to verify this information, as remembering whether or not medication was taken, and taken in the proper dose, is a common problem for users.

A visual indicator on the bottom of the electronic medication dispenser can light up or provide a visual indication when the electronic medication dispenser is raised into the air or is no longer seated with its bottom down. The visual indicator may assist the user in visually verifying the transfer between the dispensing system and the receiving entity of the electronic medication dispenser. Once the transfer of the medication has been completed between the dispensing system and the receiving entity of the electronic medication dispenser the visual indicator can go off, a beeping or other audio effect noise can be generated by an audible indicator, by either, or both, dispensing system and the receiving entity (e.g., a needle device) and a visual indicator may appear to light green or other color on the receiving entity. The visual indication and/or the audio indication may be the only alerts a user receives or there may be a second alert letting the user know that the user can remove the dispensing system and the receiving entity of the electronic medication dispenser from another, or else that the dispensing system and the receiving entity have been physically disengaged.

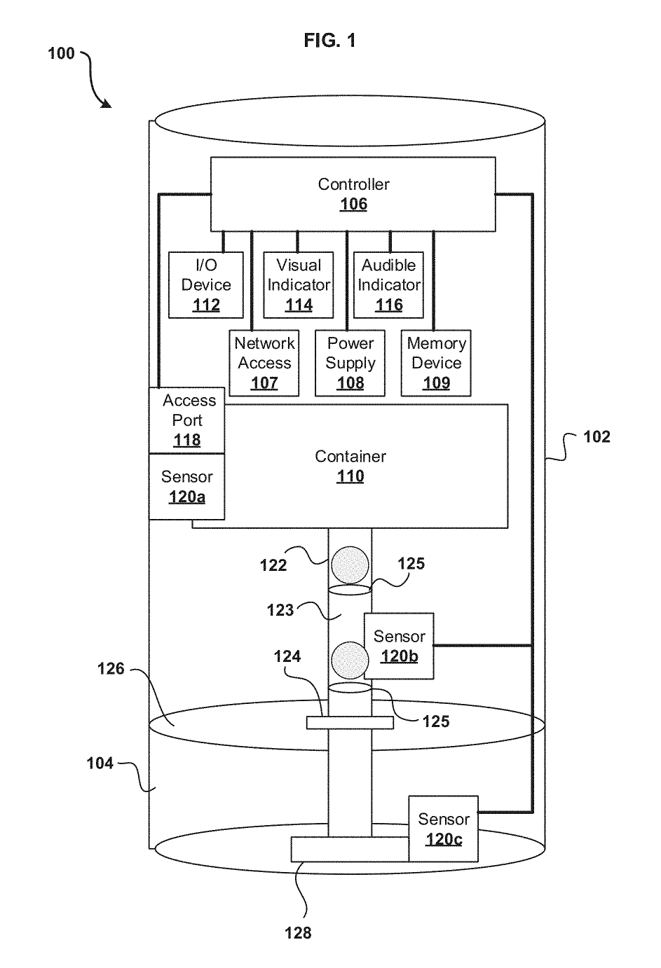

FIG. 1 is a block diagram of an exemplary electronic medication dispenser 100 as described herein. The electronic medication dispenser 100 can be configured to dispense medication such as pills, tablets, gel caps, capsules, powder, liquids, and the like, in any particular size or shape. The electronic medication dispenser 100 can comprise any suitable housing for enclosing and protecting the various components disclosed herein. The electronic medication dispenser 100 can comprise a dispensing system 102 and a receiving entity 104. The dispensing system 102 can be configured to hold and dispense the medication to the receiving entity 104 from which a user of the electronic medication dispenser 100 can obtain the medication. The electronic medication dispenser 100 can comprise a controller 106. The dispensing system 102 and/or the receiving entity 104 can comprise the controller 106 or any of the components described herein. The controller 106 can be, or can comprise, any suitable microprocessor or microcontroller, for example, a low-power application-specific controller (ASIC) and/or a field programmable gate array (FPGA) designed or programmed specifically for the task of controlling a device as described herein, or a general purpose central processing unit (CPU), for example, one based on 80×86 architecture as designed by Intel™ or AMD™, or a system-on-a-chip as designed by ARM™. The controller 106 can be coupled (e.g., communicatively, operatively, etc. . . . ) to auxiliary devices or modules of the electronic medication dispenser 100 using a bus or other coupling. The electronic medication dispenser 100 can comprise a power supply 108. The power supply 108 can comprise one or more batteries and/or other power storage device (e.g., capacitor) and/or a port for connecting to an external power supply. For example, an external power supply can supply power to the electronic medication dispenser 100 and a battery can store at least a portion of the supplied power. The one or more batteries can be rechargeable. The one or more batteries can comprise a lithium-ion battery (including thin film lithium ion batteries), a lithium ion polymer battery, a nickel-cadmium battery, a nickel metal hydride battery, a lead-acid battery, combinations thereof, and the like.

The electronic medication dispenser 100 can comprise a memory device 109 coupled to the controller 106. The memory device 109 can comprise a random access memory (RAM) configured for storing program instructions and data for execution or processing by the controller 106 during control of the electronic medication dispenser 100. When the electronic medication dispenser 100 is powered off or in an inactive state, program instructions and data can be stored in a long-term memory, for example, a non-volatile magnetic optical, or electronic memory storage device (not shown). Either or both of the RAM or the long-term memory can comprise a non-transitory computer-readable medium storing program instructions that, when executed by the controller 106, cause the electronic medication dispenser 100 to perform all or part of one or more methods and/or operations described herein. Program instructions can be written in any suitable high-level language, for example, C, C++, C# or the Java™, and compiled to produce machine-language code for execution by the controller 106.

In an aspect, the electronic medication dispenser 100 can comprise a network access device 107 allowing the electronic medication dispenser 100 to be coupled to one or more ancillary devices (not shown) such as via an access point (not shown) of a wireless telephone network, local area network, or other coupling to a wide area network, for example, the Internet. In that regard, the controller 106 can be configured to share data with the one or more ancillary devices via the network access device 107. The shared data can comprise, for example, usage data and/or operational data of the electronic medication dispenser 100, a status of the electronic medication dispenser 100, a status and/or operating condition of one or more the components of the electronic medication dispenser 100, text to be used in a message, a product order, payment information, amount of medication used, when the medication was used, how much medication remains, and/or any other data. Similarly, the controller 106 can be configured to receive control instructions from the one or more ancillary devices via the network access device 107. For example, a configuration of the electronic medication dispenser 100, an operation of the electronic medication dispenser 100, and/or other settings of the electronic medication dispenser 100, can be controlled by the one or more ancillary devices via the network access device 107. For example, an ancillary device can comprise a server that can provide various services and another ancillary device can comprise a smartphone for controlling operation of the electronic medication dispenser 100. In some aspects, the smartphone or another ancillary device can be used as a primary input/output of the electronic medication dispenser 100 such that data is received by the electronic medication dispenser 100 from the server, transmitted to the smartphone, and output on a display of the smartphone. In an aspect, data transmitted to the ancillary device can comprise an amount of medication and/or instructions to dispense the medication. For example, the electronic medication dispenser 100 can be configured to determine a need for the release of medication into the receiving entity 104. The electronic medication dispenser 100 can provide instructions via the network access device 107 to an ancillary device (e.g., another electronic medication dispenser) to release medication into the receiving entity 104.

In an aspect, the electronic medication dispenser 100 can also comprise an input/output device 112 coupled to one or more of the controller 106, the network access device 107, and/or any other electronic component of the electronic medication dispenser 100. Input can be received from a user or another device and/or output can be provided to a user or another device via the input/output device 112. The input/output device 112 can comprise any combinations of input and/or output devices such as buttons, knobs, keyboards, touchscreens, visual indicator 114 (e.g., displays, light-emitting elements), audible indicator 116 (e.g., a speaker), and/or the like. In an aspect, the input/output device 112 can comprise an interface port (not shown) such as a wired interface, for example a serial port, a Universal Serial Bus (USB) port, an Ethernet port, or other suitable wired connection. The input/output device 112 can comprise a wireless interface (not shown), for example a transceiver using any suitable wireless protocol, for example WiFi (IEEE 802.11), Bluetooth®, infrared, or other wireless standard. For example, the input/output device 112 can communicate with a smartphone via Bluetooth® such that the inputs and outputs of the smartphone can be used by the user to interface with the electronic medication dispenser 100. In an aspect, the input/output device 112 can comprise a user interface. The user interface user interface can comprise at least one of lighted signal lights, gauges, boxes, forms, check marks, avatars, visual images, graphic designs, lists, active calibrations or calculations, 2D interactive fractal designs, 3D fractal designs, 2D and/or 3D representations of medication dispensers and other interface system functions.

In an aspect, the input/output device 112 can comprise a touchscreen interface and/or a biometric interface. For example, the input/output device 112 can include controls that allow the user to interact with and input information and commands to the electronic medication dispenser 100. For example, with respect to the embodiments described herein, the input/output device 112 can comprise a touch screen display. The input/output device 112 can be configured to provide content, which is presented to the user via the functionality of a display. User inputs to the touch screen display are processed by, for example, the input/output device 112 and/or the controller 106. The input/output device 112 can also be configured to process new content and communications to the electronic medication dispenser 100. The touch screen display can provide controls and menu selections, and process commands and requests. Application and content objects can be provided by the touch screen display. The input/output device 112 and/or the controller 106 can receive and interpret commands and other inputs, interface with the other components of the electronic medication dispenser 100 as required. In an aspect, the touch screen display can enable a user to lock, unlock, or partially unlock or lock, the electronic medication dispenser 100. The electronic medication dispenser 100 can be transitioned from an idle and locked state into an open state by, for example, moving or dragging an icon on the screen of the electronic medication dispenser 100, entering in a password/passcode, and the like. The input/output device 112 can thus display information to a user such as a medication count taken, last time medication was dispensed, an amount of medication remaining in a medication container 110, battery remaining, signal strength, combinations thereof, and the like.

In an aspect, the input/output device 112 can comprise an audio user interface. A microphone can be configured to receive audio signals and relay the audio signals to the input/output device 112. The audio user interface can be any interface that is responsive to voice or other audio commands. The audio user interface can be configured to cause an action, activate a function, and the like, by the electronic medication dispenser 100 (or another device) based on a received voice (or other audio) command. The audio user interface can be deployed directly on the electronic medication dispenser 100 and/or via other electronic devices (e.g., electronic communication devices such as a smartphone, a smart watch, a tablet, a laptop, a dedicated audio user interface device, and the like). The audio user interface can be used to control the functionality of the electronic medication dispenser 100. Such functionality can comprise, but is not limited to, dispensing medication (e.g., pills) and/or ordering refills combinations via an eCommerce service (e.g., specifications of a user's prescription can be transmitted to an eCommerce service, so that a pharmacist can refill a prescription for the user). The user can then refill the medication prescription, all via the audio user interface. The audio user interface can be secured via a password (e.g., audio password) which features at least one of tone recognition, other voice quality recognition and, in one aspect, can utilize at least one special cadence as part of the audio password.

The input/output device 112 can be configured to interface with other devices, for example, exercise equipment, computing equipment, communications devices and/or other electronic medication dispensers, for example, via a physical or wireless connection. The input/output device 112 can thus exchange data with the other equipment. A user may sync their electronic medication dispenser 100 to other devices, via programming attributes such as mutual dynamic link library (DLL) ‘hooks’. This enables a smooth exchange of data between devices, as can a web interface between devices. The input/output device 112 can be used to upload one or more profiles to the other devices.

In an aspect, the electronic medication dispenser 100 can comprise an access port 118 to the dispensing component 102. For example, the access port 118 can be a removable cap, a hatch, door, and the like. The access port 118 can be configured to access one or more containers 110 to insert/remove medication into and out of the one or more containers 110, for example. Each of the one or more containers 110 can be configured to hold one or more medications. The access port can be made from a durable material such as flexible plastic, rubber, and the like, and can be configured to be removably attached to the electronic medication dispenser 100 via internal threading and the like. The access port 118 can comprise a locking mechanism that is coupled to the controller 106. The locking mechanism can be configured to prevent unauthorized individuals from removing the access port 118 or accessing through the access port 118 and/or accessing the one or more containers 110 through the access port 118. The locking mechanism can secure the access port by 118 by allowing only access once the electronic medication dispenser 100 has received a verification/authorization instruction via a matching frequency (e.g., 107.8 kHz) creating an electronic data handshake, software verification, physical hardware lock-and-key matching, and the like. The verification can be reset via a password or a security control setting.

In an aspect, the electronic medication dispenser 100 can comprise a dispensing channel 122. The dispensing channel 122 can be configured in the dispensing system 102 of the electronic medication dispenser 100. The dispensing channel 122 can be configured to release medication at a specific dose for the user that is prescribed by instructions stored in the memory device 109. As an example, the dispensing channel 122 can comprise one or more chambers 123 that are individually defined by one or more gates 125 to hold a medication dose, such as a pill. Each chamber 123 can be channeled and released toward the dispensing exit to the receiving component 104 by a pressure gauge which moves downward in accordance with instructions stored in the memory device 109 and executed by the controller 106. The dispensing channel 122 can dispense the medication from the dispensing system 102 to the receiving entity 104 through an internal lock 124. The internal lock 124 can be configured to open for an amount of time that allows a proper dose of medication to the receiving entity 104.

As another example, the dispensing channel 122 can comprise a separator system where plastic, metal, or a natural material is used to create a separator between/among medication. The specific dose of the medication can be delivered to a last separator before exiting the dispensing channel 122 and being received by the receiving entity 104. The last separator can be the internal lock 124. The separators can be the gates 125. The separators can be in the form of a valve (e.g., a bicuspid valve, a butterfly valve, a tricuspid valve). The separators can be hinged or retractable. The controller 106 can regulate the opening and closing of the separators according to specific dose instructions stored in the memory device 109. For example, medication in the form of pills can be individually separated or separated by dose if more than one pill is required per dosage.

As another example, the dispensing channel 122 can be configured as a rotary wheel coupled to a motor configured to rotate the rotary wheel. The rotary wheel can comprise one or more recesses that are configured for a particular dose of medication (e.g., a particular pill size and shape, a particular amount of medication by volume, and the like). The recess can be adjustable to fit a particular medication or dose. As the rotary wheel rotates by the motor according the instructions executed by the controller 106 the recess can receive the medication when aligned with an opening of the container 110. The rotary wheel can continue turning after the medication is received. As the recess is aligned with the internal lock or with an exit of the dispensing channel 122, gravity or a mechanical force can cause the medication to be released from the recess and be received by the receiving entity 104.

In an aspect, the dispensing system 102 and the receiving entity 104 can be locked together via a lock 126. The dispensing system 102 can be configured to always be sealed to the user and only allowed access by an authorized third party such a pharmacist. The lock 126 can release when the dispensing system 102 has dispensed the medication into the receiving entity 104. The user can then access the receiving entity to receive the medication.

In an aspect, the electronic medication dispenser 100 can comprise a user access port 128. The user access port 128 can open when medication has been released into the receiving entity 104 from the dispensing system 102. The user port 128 can be configured to remain locked unless a verification operation is performed to ensure that the user prescribed the medication is actually receiving the medication.

In an aspect, the electronic medication dispenser 100 can comprise one or more sensors 120 (e.g., sensors 120a, 120b, and 120c). The one or more sensor can be configured to measure the amount of medication moving between the various compartments of the electronic medication dispenser 100. The one or more sensors 120 can be one or more counters, scales, and the like. For example, sensor 120a can measure the amount of medication entering the container 110 and that is present in container 110. Sensor 120b can measure the amount of medication being dispensed to the receiving entity 104. Sensor 120c can measure the amount and/or presence of medication in the receiving entity 104. The one or more sensors 120 can be in communication with the controller 106 and cause the controller 106 to perform one or more actions based on the instruction in the memory device 109. For example, sensor 120b can measure that a specific dose of medication has been released into the receiving entity 104. After the specific dose has been released into the receiving entity 104, the controller 106 can cause the internal lock 124 to shut.

In an aspect, input from the input/output device 112 can be used by the controller 106 to cause the dispensing system 102 to dispense one or more medications. For example, a user can depress a button, causing the dispensing system 102 to start dispensing the one or more medications through the dispensing channel 122. In various aspects, the controller 106 can control medication dispensing and flow to the user access port 128 based on data detected by the one or more sensors 120. For example, a user can activate the electronic medication dispenser to dispense medication. In response, the controller 106 can cause the dispensing channel to begin dispensing the one or more medications, terminate dispensing the one or more medications, and/or otherwise adjust a rate of dispensing of the one or more medications.

In another aspect, the one or more sensors 120 can be configured to sense negative environmental conditions (e.g., adverse weather, smoke, fire, chemicals (e.g., such as CO2 or formaldehyde), adverse pollution, and/or disease outbreaks, moisture, incorrect orientation of the electronic medication dispenser for dispensing medication, and the like). The one or more sensors 120 can comprise one or more of, a biochemical/chemical sensor, a thermal sensor, a radiation sensor, a mechanical sensor, an optical sensor, a mechanical sensor, a magnetic sensor, an electrical sensor, combinations thereof and the like. The biochemical/chemical sensor can be configured to detect one or more biochemical/chemicals causing a negative environmental condition such as, but not limited to, smoke, a vapor, a gas, a liquid, a solid, an odor, combinations thereof, and/or the like. The biochemical/chemical sensor can comprise one or more of a mass spectrometer, a conducting/nonconducting regions sensor, a SAW sensor, a quartz microbalance sensor, a conductive composite sensor, a chemiresitor, a metal oxide gas sensor, an organic gas sensor, a MOSFET, a piezoelectric device, an infrared sensor, a sintered metal oxide sensor, a Pd-gate MOSFET, a metal FET structure, a electrochemical cell, a conducting polymer sensor, a catalytic gas sensor, an organic semiconducting gas sensor, a solid electrolyte gas sensors, a piezoelectric quartz crystal sensor, and/or combinations thereof.

The thermal sensor can be configured to detect temperature, heat, heat flow, entropy, heat capacity, combinations thereof, and the like. Exemplary thermal sensors include, but are not limited to, thermocouples, such as a semiconducting thermocouples, noise thermometry, thermoswitches, thermistors, metal thermoresistors, semiconducting thermoresistors, thermodiodes, thermotransistors, calorimeters, thermometers, indicators, and fiber optics.

The radiation sensor can be configured to detect gamma rays, X-rays, ultra-violet rays, visible, infrared, microwaves and radio waves. Exemplary radiation sensors are suitable for use in the present invention that include, but are not limited to, nuclear radiation microsensors, such as scintillation counters and solid state detectors, ultra-violet, visible and near infrared radiation microsensors, such as photoconductive cells, photodiodes, phototransistors, infrared radiation microsensors, such as photoconductive IR sensors and pyroelectric sensors.

The optical sensor can be configured to detect visible, near infrared, and infrared waves. The mechanical sensor can be configured to detect displacement, velocity, acceleration, force, torque, pressure, mass, flow, acoustic wavelength, and amplitude. Exemplary mechanical sensors are suitable for use in the present invention and include, but are not limited to, displacement microsensors, capacitive and inductive displacement sensors, optical displacement sensors, ultrasonic displacement sensors, pyroelectric, velocity and flow microsensors, transistor flow microsensors, acceleration microsensors, piezoresistive microaccelerometers, force, pressure and strain microsensors, and piezoelectric crystal sensors. The magnetic sensor can be configured to detect magnetic field, flux, magnetic moment, magnetization, and magnetic permeability. The electrical sensor can be configured to detect charge, current, voltage, resistance, conductance, capacitance, inductance, dielectric permittivity, polarization and frequency.

Upon sensing a negative environmental condition, the one or more sensors 120 can provide data to the controller to determine the nature of the negative environmental condition and to generate/transmit one or more alerts based on the negative environmental condition. The one or more alerts can be deployed to the electronic medication dispenser 100 user's wireless device and/or synced accounts. For example, the network device access device 107 can be used to transmit the one or more alerts directly (e.g., via Bluetooth®) to a user's smartphone to provide information to the user. In another aspect, the network access device 107 can be used to transmit sensed information and/or the one or more alerts to a remote server for use in syncing one or more other devices used by the user (e.g., other electronic medication devices, other electronic devices (smartphones, tablets, laptops, etc. . . . ). In another aspect, the one or more alerts can be provided to the user of the electronic medication dispenser 100 via vibrations, audio, colors, and the like deployed from the mask, for example through the input/output device 112. For example, the input/output device 112 can comprise a small vibrating motor to alert the user to one or more sensed conditions via tactile sensation. In another example, the input/output device 112 can comprise one or more visual indicators 114 such as LEDs of various colors to provide visual information to the user. In another example, the input/output device 112 can comprise one or more audible indicators 116 such as speakers that can provide audio information to the user. For example, various patterns of beeps, sounds, and/or voice recordings can be utilized to provide the audio information to the user. In another example, the input/output device 112 can comprise an LCD screen/touchscreen that provides a summary and/or detailed information regarding the negative environmental condition and/or the one or more alerts.

In another aspect, upon sensing a negative environmental condition, the one or more sensors 120 can provide data to the controller 106 to determine the nature of the negative environmental condition and to provide a recommendation for mitigating and/or to actively mitigate the negative environmental condition. Mitigating the negative environmental conditions can comprise, for example, applying a filtration system, a fan, a fire suppression system, engaging a HVAC system, and/or dispense one or more medications. The controller 106 can access a database stored in the memory device 109 to make such a determination or the network access device 107 can be used to request information from a server to verify the sensor findings. In an aspect, the server can provide an analysis service to the electronic medication dispenser 100. For example, the server can analyze data sent by the electronic medication dispenser 100 based on a reading from the one or more sensors 120. The server can determine and transmit one or more recommendations to the electronic medication dispenser 100 to mitigate the sensed negative environmental condition. The electronic medication dispenser 100 can use the one or more recommendations to activate a filtration system, a fan, a fire suppression system engaging a HVAC system, and/or to dispense one or more medications to assist in countering effects from the negative environmental condition.

In an aspect, the one or more sensors 120 can be configured to detect whether the dispenser channel 122 has a medication within its recess. Upon detection of the medication with the recess of the dispenser channel 122, a sensor 120b (e.g., a counter) increases the count number by one. This enables the electronic medication dispenser 100 to track the number of pills or amount of medication that has been dispensed. The one or more sensors can be communicatively interconnected with the sensor 120b and the controller 106. The one or more sensors 120 may be any type of sensor, such as a movement or motion sensor, a proximity sensor, a plunger sensor, a limit switch, and others described herein. Additional sensors may be included in the electronic medication dispenser 100 to detect other occurrences, such as a sensor to detect whether the power supply 108 has available power that falls below a predetermined threshold, a sensor to detect whether the access port 118 and/or the user access port 128 is secured to the electronic medication dispenser 100, and the like.

The visual indicator(s) 114 are configured to provide a visual indication to remind the user to dispense a pill from the electronic medication dispenser 100, to indicate the time, to indicate the status of the power source, or the like. The visual indicator(s) 114 can emit light to provide the visual indication and can be light emitting diodes (LEDs) of any desired color, but may be any type of light. The audible indicator(s) 116 are configured to emit a distinctive audible sound, and may be a speaker that is powered by an amplifier to emit a buzzer, chirp, chime, or the like. Alternatively, the audible indicator 116 may be a speaker that relays audible communication information, such as a recorded message, a relayed communication message, a relayed live transmission, or the like.

The input/output device 112 can be comprise keys, buttons, or toggle switches that may be color-coded and/or may include indicia to enable a user to enter a PIN to cause the electronic medication dispenser 100 to dispense a pill/medication. The electronic medication dispenser 100 may also be configured to operate with input/output device 112 configured to operate with biometric information as input parameters, such as a finger print, voice, signature, DNA, facial structure, iris, retina, and the like. The input/output device 112 are configured to interconnect with remote computer devices using known interconnection techniques, e.g., with a cable or the like.

The electronic medication dispenser 100 can be configured to be repeatedly utilized prior to being discarded. Preferably, a pharmacy may configure an electronic medication dispenser 100 for a particular medication by programming the particular electronic medication dispenser 100 with pill dispenser parameters/control instructions for the particular medication. The control instructions can include a dosage schedule, a dosage amount, a medication expiration date, a medication refill quantity, a time interval between doses, and the like. When the dispensing channel 122 has been configured for the medication, and the electronic medication dispenser 100 is associated with a certain patient, additional pill dispenser parameters/control instructions can be provided, such as the patient name, the pharmacist name, the pharmacy name, the pharmacy address, the patient address, etc. When the patient receives the electronic medication dispenser 100, the patient may be required or may choose to configure the electronic medication dispenser 100 with a PIN or other criteria, such as biometric information, to be required to be entered prior to dispensing the medication. This prevents unauthorized users from obtaining the medication, and can also prevent the patient from receiving the medication at unauthorized times.

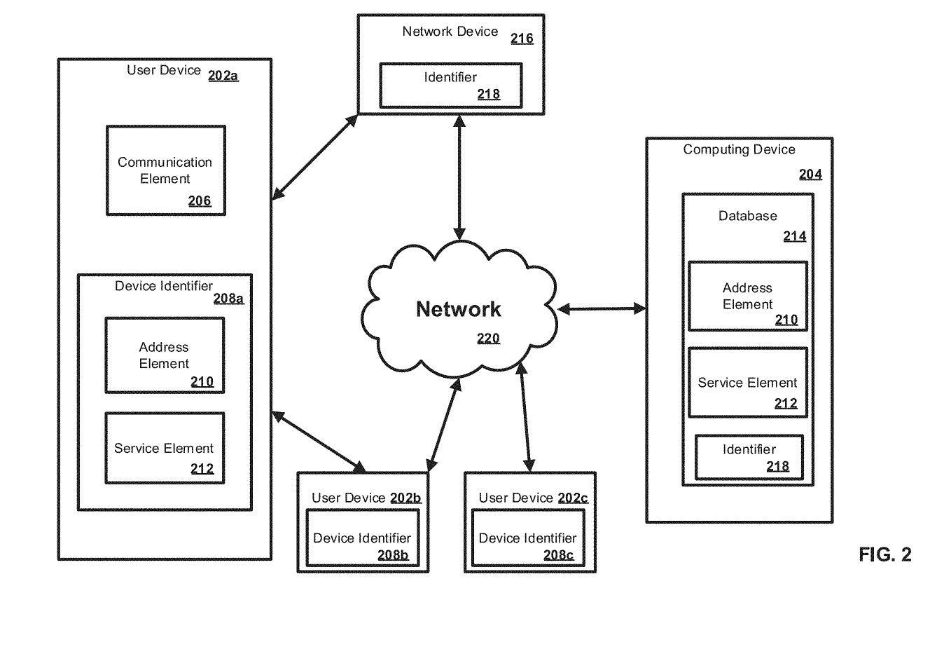

In one aspect of the disclosure, a system can be configured to provide services such as network-related services to a user device. FIG. 2 illustrates various aspects of an exemplary environment in which the present methods and systems can operate. The present disclosure is relevant to systems and methods for providing services to a user device, for example, electronic medication dispenser, which can include, but are not limited to, an electronic pill bottle, a needle and syringe, an intravenous system, an electronic injection system, any other medication container, and the like. Other user devices that can be used in the systems and methods include, but are not limited to, a smart watch (and any other form of “smart” wearable technology), a smartphone, a tablet, a laptop, a desktop, and the like. In an aspect, one or more network devices can be configured to provide various services to one or more devices, such as devices located at or near a premises. In another aspect, the network devices can be configured to recognize an authoritative device for the premises and/or a particular service or services available at the premises. As an example, an authoritative device can be configured to govern or enable connectivity to a network such as the Internet or other remote resources, provide address and/or configuration services like DHCP, and/or provide naming or service discovery services for a premises, or a combination thereof. Those skilled in the art will appreciate that present methods may be used in various types of networks and systems that employ both digital and analog equipment. One skilled in the art will appreciate that provided herein is a functional description and that the respective functions can be performed by software, hardware, or a combination of software and hardware.

The network and system can comprise a user device 202a, 202b, and/or 202c in communication with a computing device 204 such as a server, for example. The computing device 204 can be disposed locally or remotely relative to the user device 202a, 202b, and/or 202c. As an example, the user device 202a, 202b, and/or 202c and the computing device 204 can be in communication via a private and/or public network 220 such as the Internet or a local area network. Other forms of communications can be used such as wired and wireless telecommunication channels, for example. In another aspect, the user device 202a, 202b, and/or 202c can communicate directly without the use of the network 220 (for example, via Bluetooth®, infrared, and the like).

In an aspect, the user device 202a, 202b, and/or 202c can be an electronic device such as an electronic medication dispenser (e.g., an electronic pill bottle, intravenous delivery system, a needle and syringe, and the like), a smartphone, a smart watch, a computer, a smartphone, a laptop, a tablet, a set top box, a display device, or other device capable of communicating with the computing device 204. As an example, the user device 202a, 202b, and/or 202c can comprise a communication element 206 for providing an interface to a user to interact with the user device 202a, 202b, and/or 202c and/or the computing device 204. The communication element 206 can be any interface for presenting and/or receiving information to/from the user, such as user feedback. An example interface may be communication interface such as a web browser (e.g., Internet Explorer, Mozilla Firefox, Google Chrome, Safari, or the like). Other software, hardware, and/or interfaces can be used to provide communication between the user and one or more of the user device 202a, 202b, and/or 202c and the computing device 204. In an aspect, the user device 202a, 202b, and/or 202c can have at least one similar interface quality such as a symbol, a voice activation protocol, a graphical coherence, a startup sequence continuity element of sound, light, vibration or symbol. In an aspect, the interface can comprise at least one of lighted signal lights, gauges, boxes, forms, words, video, audio scrolling, user selection systems, vibrations, check marks, avatars, matrix', visual images, graphic designs, lists, active calibrations or calculations, 2D interactive fractal designs, 3D fractal designs, 2D and/or 3D representations of vapor devices and other interface system functions.

As an example, the communication element 206 can request or query various files from a local source and/or a remote source. As a further example, the communication element 206 can transmit data to a local or remote device such as the computing device 204.

In an aspect, the user device 202a, 202b, and/or 202c can be associated with a user identifier or device identifier 208a, 208b, and/or 208c. As an example, the device identifier 208a, 208b, and/or 208c can be any identifier, token, character, string, or the like, for differentiating one user or user device (e.g., user device 202a, 202b, and/or 202c) from another user or user device. In a further aspect, the device identifier 208a, 208b, and/or 208c can identify a user or user device as belonging to a particular class of users or user devices. As a further example, the device identifier 208a, 208b, and/or 208c can comprise information relating to the user device such as a manufacturer, a model or type of device, a service provider associated with the user device 202a, 202b, and/or 202c, a state of the user device 202a, 202b, and/or 202c, a locator, and/or a label or classifier. Other information can be represented by the device identifier 208a, 208b, and/or 208c.

In an aspect, the device identifier 208a, 208b, and/or 208c can comprise an address element 210 and a service element 212. In an aspect, the address element 210 can comprise or provide an internet protocol address, a network address, a media access control (MAC) address, an Internet address, or the like. As an example, the address element 210 can be relied upon to establish a communication session between the user device 202a, 202b, and/or 202c and the computing device 204 or other devices and/or networks. As a further example, the address element 210 can be used as an identifier or locator of the user device 202a, 202b, and/or 202c. In an aspect, the address element 210 can be persistent for a particular network.

In an aspect, the service element 212 can comprise an identification of a service provider associated with the user device 202a, 202b, and/or 202c and/or with the class of user device 202a, 202b, and/or 202c. The class of the user device 202a, 202b, and/or 202c can be related to a type of device, capability of device, type of service being provided, and/or a level of service. As an example, the service element 212 can comprise information relating to or provided by a communication service provider (e.g., Internet service provider) that is providing or enabling data flow such as communication services to and/or between the user device 202a, 202b, and/or 202c. As a further example, the service element 212 can comprise information relating to a preferred service provider for one or more particular services relating to the user device 202a, 202b, and/or 202c. In an aspect, the address element 210 can be used to identify or retrieve data from the service element 212, or vice versa. As a further example, one or more of the address element 210 and the service element 212 can be stored remotely from the user device 202a, 202b, and/or 202c and retrieved by one or more devices such as the user device 202a, 202b, and/or 202c and the computing device 204. Other information can be represented by the service element 212.

In an aspect, the computing device 204 can be a server for communicating with the user device 202a, 202b, and/or 202c. As an example, the computing device 204 can communicate with the user device 202a, 202b, and/or 202c for providing data and/or services. As an example, the computing device 204 can provide services such as data sharing, data syncing, network (e.g., Internet) connectivity, network printing, media management (e.g., media server), content services, streaming services, broadband services, or other network-related services. In an aspect, the computing device 204 can allow the user device 202a, 202b, and/or 202c to interact with remote resources such as data, devices, and files. As an example, the computing device can be configured as (or disposed at) a central location, which can receive content (e.g., data) from multiple sources, for example, user devices 202a, 202b, and/or 202c. The computing device 204 can combine the content from the multiple sources and can distribute the content to user (e.g., subscriber) locations via a distribution system.

In an aspect, one or more network devices 216 can be in communication with a network such as network 220. As an example, one or more of the network devices 216 can facilitate the connection of a device, such as user device 202a, 202b, and/or 202c, to the network 220. As a further example, one or more of the network devices 216 can be configured as a wireless access point (WAP). In an aspect, one or more network devices 216 can be configured to allow one or more wireless devices to connect to a wired and/or wireless network using Wi-Fi, Bluetooth or any desired method or standard.

In an aspect, the network devices 216 can be configured as a local area network (LAN). As an example, one or more network devices 216 can comprise a dual band wireless access point. As an example, the network devices 216 can be configured with a first service set identifier (SSID) (e.g., associated with a user network or private network) to function as a local network for a particular user or users. As a further example, the network devices 216 can be configured with a second service set identifier (SSID) (e.g., associated with a public/community network or a hidden network) to function as a secondary network or redundant network for connected communication devices.

In an aspect, one or more network devices 216 can comprise an identifier 218. As an example, one or more identifiers can be or relate to an Internet Protocol (IP) Address IPV4/IPV6 or a media access control address (MAC address) or the like. As a further example, one or more identifiers 218 can be a unique identifier for facilitating communications on the physical network segment. In an aspect, each of the network devices 216 can comprise a distinct identifier 218. As an example, the identifiers 218 can be associated with a physical location of the network devices 216.

In an aspect, the computing device 204 can manage the communication between the user device 202a, 202b, and/or 202c and a database 214 for sending and receiving data therebetween. As an example, the database 214 can store a plurality of files (e.g., web pages), user identifiers or records, or other information. In one aspect, the database 214 can store user device 202a, 202b, and/or 202c usage information (including chronological usage), type of medication material used, time when medication last taken, amount of medication, frequency of usage, location of usage, recommendations, communications (e.g., text messages, advertisements, photo messages), simultaneous use of multiple devices, and the like). The database 214 can collect and store data to support cohesive use, wherein cohesive use is indicative of the use of a first electronic medication dispenser and then a second electronic medication dispenser is synced chronologically and logically to provide the proper specific properties and amount of medication based upon a designed usage cycle. As a further example, the user device 202a, 202b, and/or 202c can request and/or retrieve a file from the database 214. The user device 202a, 202b, and/or 202c can thus sync locally stored data with more current data available from the database 214. Such syncing can be set to occur automatically on a set time schedule, on demand, and/or in real-time. The computing device 204 can be configured to control syncing functionality. For example, a user can select one or more of the user device 202a, 202b, and/or 202c to never by synced, to be the master data source for syncing, and the like. Such functionality can be configured to be controlled by a master user and any other user authorized by the master user or agreement.

In an aspect, data can be derived by system and/or device analysis. Such analysis can comprise at least by one of instant analysis performed by the user device 202a, 202b, and/or 202c or archival data transmitted to a third party for analysis and returned to the user device 202a, 202b, and/or 202c and/or computing device 204. The result of either data analysis can be communicated to a user of the user device 202a, 202b, and/or 202c to, for example, inform the user of their medication use. In an aspect, a result can be transmitted back to at least one authorized user interface.

In an aspect, the database 214 can store information relating to the user device 202a, 202b, and/or 202c such as the address element 210 and/or the service element 212. As an example, the computing device 204 can obtain the device identifier 208a, 208b, and/or 208c from the user device 202a, 202b, and/or 202c and retrieve information from the database 214 such as the address element 210 and/or the service elements 212. As a further example, the computing device 204 can obtain the address element 210 from the user device 202a, 202b, and/or 202c and can retrieve the service element 212 from the database 214, or vice versa. Any information can be stored in and retrieved from the database 214. The database 214 can be disposed remotely from the computing device 204 and accessed via direct or indirect connection. The database 214 can be integrated with the computing device 204 or some other device or system.

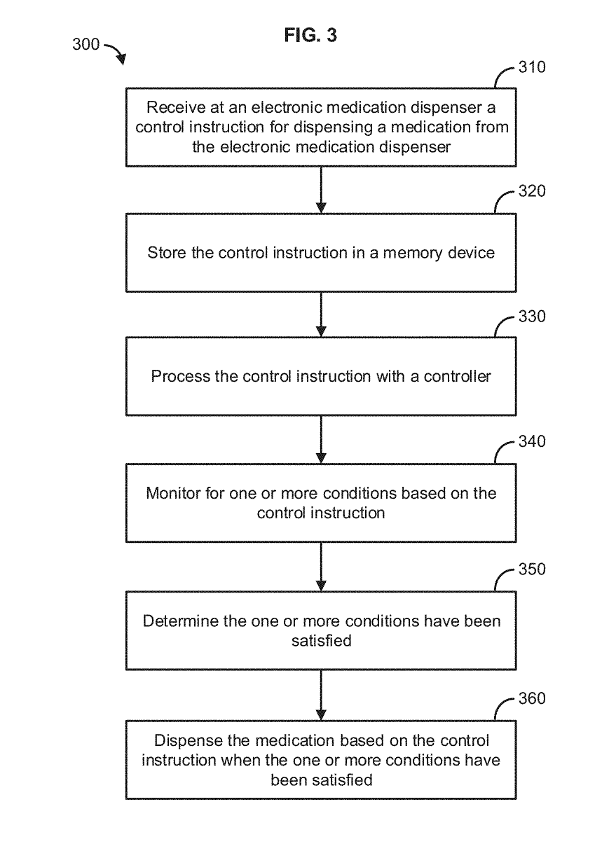

In an aspect, illustrated in FIG. 3, provided is a method 300 comprising receiving at an electronic medication dispenser a control instruction for dispensing a medication from the electronic medication dispenser at 310. The control instruction can comprise one or more of a dose of the medication, a time of dispensing the medication, duration of a treatment with the medication, authorized users of the electronic medication dispenser, refill information of the medication, expiration date of the medication, and the like.

The method 300 can comprise storing the control instruction in a memory device at 320. The control instructions can be accessible by a controller. The controller can process the control instructions at 330. The controller can monitor for one or more conditions (e.g., time, date, authorization information, and the like) based on the control instructions at 340.

The method 300 can comprise determining the one or more conditions have been satisfied at step 350. The controller can determine whether the one or more conditions have been satisfied. The medication can be dispensed based on the control instructions when the one or more conditions have been satisfied at 360. The medication can be dispensed into a receiving entity. The receiving entity can be accessed by an authorized user.

The method 300 can further comprise receiving the medication in a container of the electronic medication dispenser through an access port. The access port can be configured to be accessed by authorized users.

The method 300 can further comprise monitoring one or more sensors. The controller can determine an amount of medication remaining in the electronic medication dispenser via the one or more sensors and indicate to the user how much medication is remaining. The controller can also determine when medication has been dispensed via the one or more sensors and indicate to the user when the medication has been dispensed. The controller can further determine when the medication that has been dispensed has been removed from the electronic medication dispenser via the one or more sensors and indicate to the user one or more times when the medication that has been dispensed has been removed.

The method 300 can further comprise determining an amount of the medication being dispensed by the electronic medication dispenser via one or more sensors, comparing the amount to a dose amount according to the control instructions, and discontinuing dispense of the medication when the dose amount has been satisfied.

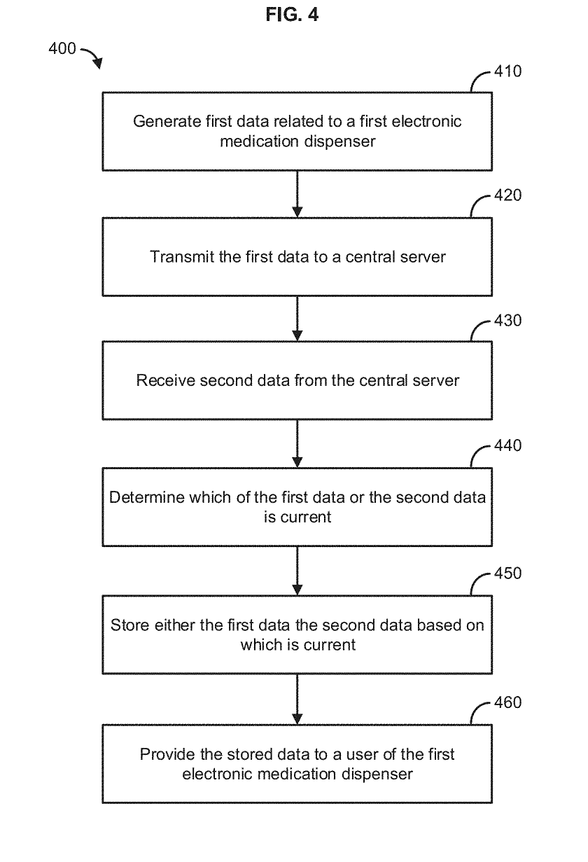

In an aspect, illustrated in FIG. 4, provided is a method 400 comprising generating first data related to a first electronic medication dispenser at 410. Generating first data related to an electronic medication dispenser can comprise determining one or more of usage information (including chronological usage), type of medication used, amount of medication used, frequency of usage, location of usage, recommendations, communications (e.g., text messages, advertisements, photo messages), and simultaneous use of multiple devices. The electronic medication dispenser can comprise one or more of a pill bottle, an intravenous system, a syringe and needle, and the like.

The method 400 can comprise transmitting the first data to a central server at 420. Transmitting the first data to a central server can comprise one or more of cellular communication, WiFi communication, Bluetooth® communication, and satellite communication.

The method 400 can comprise receiving second data from the central server at 430. The second data can comprise one or more of usage information (including chronological usage), type of medication used, amount of medication used, frequency of usage, location of usage, recommendations, communications (e.g., text messages, advertisements, photo messages), and simultaneous use of multiple devices, generated by a second electronic medication device. The method 400 can comprise determining which of the first data or the second data is current at 440. Determining which of the first data or the second data is current can comprise comparing one or more timestamps associated with the first data and the second data.

The method 400 can comprise storing either the first data the second data based on which is current at 450. The method 400 can comprise providing the stored data to a user of the first electronic medication dispenser at 460.

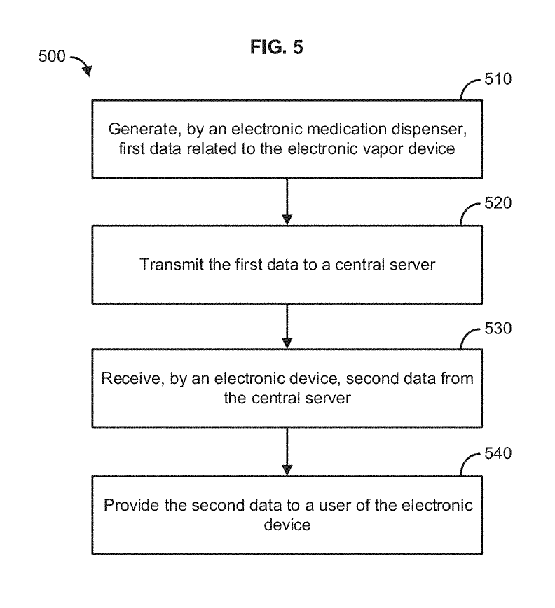

In another aspect, illustrated in FIG. 5, provided is a method 500 comprising generating, by an electronic medication dispenser, first data related to the electronic medication dispenser at 510. Generating, by an electronic medication dispenser, first data related to the electronic medication dispenser can comprise determining one or more of usage information (including chronological usage), type of medication used, amount of medication used, frequency of usage, location of usage, recommendations, communications (e.g., text messages, advertisements, photo messages), and simultaneous use of multiple devices. The electronic medication dispenser can comprise one or more of a pill bottle, an intravenous system, a syringe and needle, and the like.

The method 500 can comprise transmitting the first data to a central server at 520. Transmitting the first data to a central server can comprise one or more of cellular communication, WiFi communication, Bluetooth® communication, and satellite communication.

The method 500 can comprise receiving, by an electronic device, second data from the central server, wherein the second data comprises the first data at 530. The electronic device can comprise one or more of a smart watch, wearable technology, a smartphone, a tablet, a laptop, and a desktop. The second data can comprise third data correlated with the first data. The third data can comprise one or more of usage information (including chronological usage), type of medication used, amount of medication used, frequency of usage, location of usage, recommendations, communications (e.g., text messages, advertisements, photo messages), and simultaneous use of multiple devices, gathered from one or more other electronic medication dispensers and one or more other electronic devices. The method 500 can comprise providing the second data to a user of the electronic device at 540.

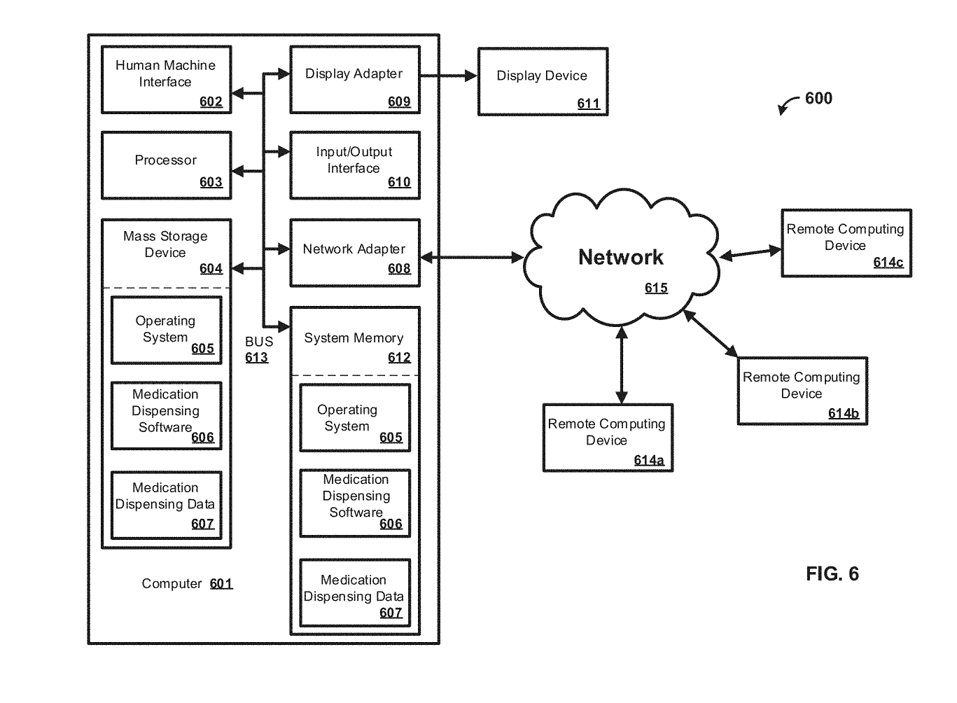

In an exemplary aspect, the methods and systems can be implemented on a computer 601 as illustrated in FIG. 6 and described below. By way of example, electronic medication dispenser 100 of FIG. 1 and the user devices 202a, 202b, 202c, the network device 216, and the computing device 204 of FIG. 2 can comprise a computer as illustrated in FIG. 6. 600 illustrates an example computer system. Similarly, the methods and systems disclosed can utilize one or more computers to perform one or more functions in one or more locations. FIG. 6 is a block diagram illustrating an exemplary operating environment for performing the disclosed methods. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The present methods and systems can be operational with numerous other general purpose or special purpose computing system environments or configurations. Examples of well-known computing systems, environments, and/or configurations that can be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, etc. that perform particular tasks or implement particular abstract data types. The disclosed methods can also be practiced in grid-based and distributed computing environments where tasks are performed by remote processing devices that are linked through a communications network. In a distributed computing environment, program modules can be located in both local and remote computer storage media including memory storage devices.

Further, one skilled in the art will appreciate that the systems and methods disclosed herein can be implemented via a general-purpose computing device in the form of a computer 601. The components of the computer 601 can comprise, but are not limited to, one or more processors 603, a system memory 612, and a system bus 613 that couples various system components including the one or more processors 603 to the system memory 612. The system can utilize parallel computing.

The system bus 613 represents one or more of several possible types of bus structures, including a memory bus or memory controller, a peripheral bus, an accelerated graphics port, or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 613, and all buses specified in this description can also be implemented over a wired or wireless network connection and each of the subsystems, including the one or more processors 603, a mass storage device 604, an operating system 605, medication dispensing software 606, medication dispensing data 607, a network adapter 608, the system memory 612, an Input/Output Interface 610, a display adapter 609, a display device 611, and a human machine interface 602, can be contained within one or more remote computing devices 614a,b,c at physically separate locations, connected through buses of this form, in effect implementing a fully distributed system.

The computer 601 typically comprises a variety of computer readable media. Exemplary readable media can be any available media that is accessible by the computer 601 and comprises, for example and not meant to be limiting, both volatile and non-volatile media, removable and non-removable media. The system memory 612 comprises computer readable media in the form of volatile memory, such as random access memory (RAM), and/or non-volatile memory, such as read only memory (ROM). The system memory 612 typically contains data such as the medication dispensing data 607 and/or program modules such as the operating system 605 and the medication dispensing software 606 that are immediately accessible to and/or are presently operated on by the one or more processors 603.

In another aspect, the computer 601 can also comprise other removable/non-removable, volatile/non-volatile computer storage media. By way of example, FIG. 6 illustrates the mass storage device 604 which can provide non-volatile storage of computer code, computer readable instructions, data structures, program modules, and other data for the computer 601. For example and not meant to be limiting, the mass storage device 604 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 604, including by way of example, the operating system 605 and the medication dispensing software 606. Each of the operating system 605 and the medication dispensing software 606 (or some combination thereof) can comprise elements of the programming and the medication dispensing software 606. The medication dispensing data 607 can also be stored on the mass storage device 604. The medication dispensing data 607 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple systems.

In another aspect, the user can enter commands and information into the computer 601 via an input device (not shown). Examples of such input devices comprise, but are not limited to, a keyboard, pointing device (e.g., a “mouse”), a microphone, a joystick, a scanner, tactile input devices such as gloves, and other body coverings, and the like These and other input devices can be connected to the one or more processors 603 via the human machine interface 602 that is coupled to the system bus 613, but can be connected by other interface and bus structures, such as a parallel port, game port, an IEEE 1394 Port (also known as a Firewire port), a serial port, or a universal serial bus (USB).

In yet another aspect, the display device 611 can also be connected to the system bus 613 via an interface, such as the display adapter 609. It is contemplated that the computer 601 can have more than one display adapter 609 and the computer 601 can have more than one display device 611. For example, the display device 611 can be a monitor, an LCD (Liquid Crystal Display), or a projector. In addition to the display device 611, other output peripheral devices can comprise components such as speakers (not shown) and a printer (not shown) which can be connected to the computer 601 via the Input/Output Interface 610. Any step and/or result of the methods can be output in any form to an output device. Such output can be any form of visual representation, including, but not limited to, textual, graphical, animation, audio, tactile, and the like. The display device 611 and computer 601 can be part of one device, or separate devices.

The computer 601 can operate in a networked environment using logical connections to one or more remote computing devices 614a,b,c. By way of example, a remote computing device can be a personal computer, portable computer, smartphone, a server, a router, a network computer, a peer device or other common network node, and so on. Logical connections between the computer 601 and a remote computing device 614a,b,c can be made via a network 615, such as a local area network (LAN) and/or a general wide area network (WAN). Such network connections can be through the network adapter 608. The network adapter 608 can be implemented in both wired and wireless environments. Such networking environments are conventional and commonplace in dwellings, offices, enterprise-wide computer networks, intranets, and the Internet.

For purposes of illustration, application programs and other executable program components such as the operating system 605 are illustrated herein as discrete blocks, although it is recognized that such programs and components reside at various times in different storage components of the computing device 601, and are executed by the one or more processors 603 of the computer. An implementation of the medication dispensing software 606 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The methods and systems can employ Artificial Intelligence techniques such as machine learning and iterative learning. Examples of such techniques include, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

In view of the exemplary systems described supra, methodologies that may be implemented in accordance with the disclosed subject matter have been described with reference to several flow diagrams. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described herein. Additionally, it should be further appreciated that the methodologies disclosed herein are capable of being stored on an article of manufacture to facilitate transporting and transferring such methodologies to computers.

Those of skill would further appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

As used in this application, the terms “component,” “module,” “system,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

Various aspects presented in terms of systems can comprise a number of components, modules, and the like. It is to be understood and appreciated that the various systems may include additional components, modules, etc. and/or may not include all of the components, modules, etc. discussed in connection with the figures. A combination of these approaches can also be used.

In addition, the various illustrative logical blocks, modules, and circuits described in connection with certain aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, system-on-a-chip, or state machine. A processor may also be implemented as a combination of computing devices, e.g., a combination of a DSP and a microprocessor, a plurality of microprocessors, one or more microprocessors in conjunction with a DSP core, or any other such configuration.

Operational aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, a DVD disk, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC or may reside as discrete components in another device.

Furthermore, the one or more versions may be implemented as a method, apparatus, or article of manufacture using standard programming and/or engineering techniques to produce software, firmware, hardware, or any combination thereof to control a computer to implement the disclosed aspects. Non-transitory computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Those skilled in the art will recognize many modifications may be made to this configuration without departing from the scope of the disclosed aspects.

The previous description of the disclosed aspects is provided to enable any person skilled in the art to make or use the present disclosure. Various modifications to these aspects will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

1. An electronic smart pill dispensing device which dispenses pills as directed by system controllers to securely and precisely provide users with the proper medication dosage in pill form.

2. The device of claim 1, wherein the electronic smart pill dispensing device is connected to the internet via a transmitter and is programmed with software enabling the electronic smart pill dispensing device to distribute pills inside the electronic smart pill dispensing device according to system control instructions.

3. The device of claim 2, wherein the system control instructions come from any authorized healthcare, wellness, 3rd party proxy, patient or other authorized representative or automated system.

4. The device of claim 1, wherein the electronic smart pill dispensing device comprises a dispensing component and a receiving component.

5. The device of claim 4, wherein the dispensing component holds the pills and dispenses them to the receiving component.

6. The device of claim 5, wherein the receiving component and the dispensing component are physically locked together and wherein the dispensing component remains sealed to the user and where the receiving component is accessible to the user when a medication is available to be taken.

7. The device of claim 6, wherein an internal lock between the receiving component and the dispensing component is opened to allow the proper pill dosage to transfer from the dispensing component to the receiving component.

8. The device of claim 7, wherein the internal lock between the dispensing and receiving components is flush and internal of the electronic smart pill dispensing device so as to prevent access to the dispensing component.

9. The device of claim 1, wherein at least one of lights and audio speakers alert the user that the medication is empty, the medication needs to be taken or it is time to order a refill.

10. The device of claim 1, wherein the electronic smart pill dispensing device provides an indication of how much medication is left by at least one of a readout or a dial, an audio warning, and a flashing warning.

11. The device of claim 1, where the dispensing component holds pills in one or more gated individually held chambers and wherein each chamber is channeled and released toward a dispensing exit to the receiving component by a pressure gauge which moves in accordance with the system instructions.

12. The device of claim 4, wherein the receiving entity is buffered with a buffering material to preserve the integrity of the pill as the pill passes to the receiving component.

13. An apparatus comprising:
a memory comprising control instructions for dispensing a medication;
a controller, configured for determining a dose of the medication to dispense based on the control instructions;
a dispensing device comprising,
one or more containers for storing the medication, and
a dispensing channel, coupled to the processor, configured to dispense a selectable amount of the medication from each of the one or more containers based on the control instructions; and
a receiving entity coupled to the dispensing channel and configured to receive the selectable amount of the medication from the dispensing channel and provide the selectable amount of the medication to a user.

14. The apparatus of claim 13, wherein the apparatus comprises an electronic medication dispenser, an electronic pill bottle, an electronic intravenous system, and an electronic injection system.

15. The apparatus of claim 13, further comprising:
one or more sensors, and
wherein the controller is further configured for performing steps comprising,
determining medication data via the one or more sensors, wherein the medication data comprises,
determining an amount of medication being received by the container via the one or more sensors,
determining an amount of medication in the container via the one or more sensors, and
determining presence of the medication in the receiving entity via the one or more sensors.

16. The apparatus of claim 15, further comprising:
a network access device configured to transmit the medication data to a remote computing device and configured to receive control instructions.

17. The apparatus of claim 13, wherein the medication comprises one or more materials associated with one or more of a wellness effect, a homeopathic effect, medicinal effect, and/or combinations thereof.

18. The apparatus of claim 13, further comprising a user interface configured to receive one or more commands that comprise at least one of dispensing the medication, ordering the medication, and inquiring when the medication was taken last.

19. The apparatus of claim 13, further comprising an access port in communication with the controller and wherein the access port is configured to provide access to the container and configured to provide access to authorized users.

20. The apparatus of claim 13, further comprising an internal lock in communication with the controller, wherein the internal lock is configured to release the receiving entity from the dispensing device.

21. The apparatus of claim 20, wherein the user can access the medication dispensed in the receiving entity when the internal lock is disengaged.

22. The apparatus of claim 21, wherein the internal lock is disengaged when the medication is dispensed.

23. The apparatus of claim 13, further comprising a visual indicator in communication with the controller wherein the visual indicator is configured to signal the user as to a status of the apparatus.

24. The apparatus of claim 13, further comprising an audible indicator in communication with the controller, wherein the audible indicator is configured to signal the user as to a status of the apparatus.

25. The apparatus of claim 13, further comprising a user access port in communication with the controller, wherein the user access port is configured to provide access by a user of the apparatus to the medication that has been dispensed.

26. The apparatus of claim 25, wherein the user access port is configured to provide access to authorized users of the apparatus.

27. The apparatus of claim 26, wherein the controller determines whether a user is an authorized user by receiving authorization information.

28. The apparatus of claim 27, wherein the authorization information is entered through an input/output device that comprises at least one of a user input key, a fingerprint reader, a signature recognition device; a facial recognition device, a DNA recognition device, a signature recognition, an audio recognition device, and a radio frequency recognition device.

29. A method comprising:
generating first data related to a first electronic medication dispenser;
transmitting the first data to a central server;
receiving second data from the central server;
determining which of the first data or the second data is current;
storing either the first data the second data based on which is current; and
providing the stored data to a user of the first electronic medication dispenser.

30. The method of claim 29, wherein generating first data related to the electronic medication dispenser comprises determining one or more of usage information (including chronological usage), type of medication used, amount of medication used, frequency of usage, location of usage, time of usage, recommendations, communications (e.g., text messages, advertisements, photo messages), and simultaneous use of multiple devices.

31. The method of claim 29, wherein transmitting the first data to a central server comprises one or more of cellular communication, WiFi communication, Bluetooth® communication, and satellite communication.

32. The method of claim 29, wherein the second data comprises one or more of usage information (including chronological usage), type of medication used, amount of medication used, frequency of usage, location of usage, time of usage, recommendations, communications (e.g., text messages, advertisements, photo messages), and simultaneous use of multiple devices, generated by a second electronic medication dispenser.

33. The method of claim 29, wherein determining which of the first data or the second data is current comprises comparing one or more timestamps associated with the first data and the second data.

34. A method comprising:
generating, by an electronic medication dispenser, first data related to the electronic medication dispenser;
transmitting the first data to a central server;
receiving, by an electronic device, second data from the central server, wherein the second data comprises the first data; and
providing the second data to a user of the electronic device.

35. The method of claim 34, wherein generating, by the electronic medication dispenser, first data related to the electronic medication dispenser comprises determining one or more of usage information (including chronological usage), type of medication used, amount of medication used, frequency of usage, location of usage, time of usage, recommendations, communications (e.g., text messages, advertisements, photo messages), and simultaneous use of multiple devices.

36. The method of claim 34, wherein transmitting the first data to a central server comprises one or more of cellular communication, WiFi communication, Bluetooth® communication, and satellite communication.

37. The method of claim 34, wherein an electronic device comprises one or more of a smart watch, wearable technology, a smartphone, a tablet, a laptop, and a desktop.

38. The method of claim 34, wherein the second data comprises third data correlated with the first data.

39. The method of claim 38, wherein the third data comprises one or more of usage information (including chronological usage), type of medication used, amount of medication used, frequency of usage, location of usage, time of usage, recommendations, communications (e.g., text messages, advertisements, photo messages), and simultaneous use of multiple devices, gathered from one or more other electronic medication dispensers and one or more other electronic devices.

40. A method comprising:
receiving at an electronic medication dispenser a control instruction for dispensing a medication from the electronic medication dispenser;
storing the control instruction in a memory device;
processing the control instruction with a controller;
monitoring for one or more conditions of the electronic medication dispenser based on the control instruction;
determining the one or more conditions have been satisfied; and
dispensing the medication based on the control instruction when the one or more conditions have been satisfied.

41. The method of claim 40, further comprising receiving a medication in a container of the electronic medication dispenser through an access port.

42. The method of claim 41, wherein the access port is configured to be accessed by authorized users.

43. The method of claim 40, further comprising monitoring one or more sensors.

44. The method of claim 43, further comprising:
determining an amount of medication remaining in the electronic medication dispenser via the one or more sensors; and
indicating to the user how much medication is remaining.

45. The method of claim 43, further comprising:
determining when medication has been dispensed via the one or more sensors; and
indicating to the user when the medication has been dispensed.

46. The method of claim 43, further comprising:
determining when the medication that has been dispensed has been removed from the electronic medication dispenser via the one or more sensors; and
indicating to the user one or more times when the medication that has been dispensed has been removed.

47. The method of claim 40, further comprising:
determining an amount of the medication being dispensed by the electronic medication dispenser via one or more sensors;
comparing the amount to a dose amount according to the control instructions; and
discontinuing dispense of the medication when the dose amount has been satisfied.

48. The method of claim 40, wherein dispensing the medication based on the control instruction when the one or more conditions have been satisfied comprises dispensing the medication into a receiving entity.

49. The method of claim 48, wherein the receiving entity is accessible only by an authorized user.
